(19) United States
(12) Patent Application Publication
(10) Pub. No.: US 2021/0243785 A1
(43) Pub. Date: Aug. 5, 2021

(54) USER TERMINAL AND RADIO COMMUNICATION METHOD

(71) Applicant: NTT DOCOMO, INC., Tokyo (JP)

(72) Inventors: Shohei Yoshioka, Tokyo (JP); Yuki Matsumura, Tokyo (JP); Kazuki Takeda, Tokyo (JP); Satoshi Nagata, Tokyo (JP)

(73) Assignee: NTT DOCOMO, INC., Tokyo (JP)

(21) Appl. No.: 17/053,111

(22) PCT Filed: May 10, 2018
(86) PCT No.: PCT/JP2018/018225

§ 371 Date: Nov. 5, 2020

(51) Int. Cl. H04W 72/12; H04W 72/04

(52) U.S. Cl. CPC H04W 72/1284; H04W 72/0446

(57) ABSTRACT

To prevent deterioration of communication throughput and so on even when transmissions of uplink control information and one or more SRs overlap each other, a user terminal according to one aspect of the present disclosure includes: a transmitting section that transmits one or more scheduling requests; and a control section that controls transmission of the one or more scheduling requests, based on at least one of presence or absence of a configuration of a second PUCCH format, a number of configured PUCCH resource sets, and a number of scheduling request resource IDs corresponding to the one or more scheduling requests, when the one or more scheduling requests overlap uplink control information using a first PUCCH format.

### TECHNICAL FIELD

The present disclosure relates to a user terminal and a radio communication method in next-generation mobile communication systems.

### BACKGROUND ART

In the UMTS (Universal Mobile Telecommunications System) network, the specifications of Long Term Evolution (LTE) have been drafted for the purpose of further increasing high speed data rates, providing lower latency and so on (see Non-Patent Literature 1). For the purpose of further high capacity, advancement of LTE (LTE Rel. 8, Rel. 9), and so on, the specifications of LTE-A (LTE-Advanced, LTE Rel. 10, Rel. 11, Rel. 12, Rel. 13) have been drafted.

Successor systems of LTE (referred to as, for example, “FRA (Future Radio Access),” “5G (5th generation mobile communication system),” “5G+ (plus),” “NR (New Radio),” “NX (New radio access),” “FX (Future generation radio access),” “LTE Rel. 14,” “LTE Rel. 15” (or later versions), and so on) are also under study.

In existing LTE systems (for example, LTE Rel. 8 to Rel. 13), a user terminal (UE (User Equipment)) transmits uplink control information (UCI) by using a UL control channel (for example, a PUCCH (Physical Uplink Control Channel)), for example. A configuration (format) of the UL control channel is referred to as a PUCCH format and so on.

The UCI may include, for example, retransmission control information (also referred to as an HARQ-ACK, an ACK/NACK, an A/N, and so on) for DL data, a scheduling request (SR), and CSI (for example, periodic CSI (P-CSI), aperiodic CSI (A-CSI), and so on).

### CITATION LIST

### Non-Patent Literature

Non-Patent Literature 1: 3GPP TS 36.300 V8.12.0 “Evolved Universal Terrestrial Radio Access (E-UTRA) and Evolved Universal Terrestrial Radio Access Network (E-UTRAN); Overall description; Stage 2 (Release 8),” April, 2010

### SUMMARY OF INVENTION

### Technical Problem

In future radio communication systems (for example, 5G and NR), it is expected that various radio communication services be implemented in such a manner as to satisfy their respective different requirements (for example, ultra-high speed, large capacity, ultra-low latency, and so on).

For example, for NR, provision of radio communication services referred to as eMBB (enhanced Mobile Broad Band), mMTC (massive Machine Type Communication), URLLC (Ultra Reliable and Low Latency Communications), and so on has been under study.

Incidentally, in the existing LTE systems, the UE transmits a scheduling request (SR) to a base station in order to request an uplink shared channel resource for data transmission. In existing LTE, control related to the SR is performed in units of subframe being a transmission time interval (TTI) length.

In contrast, in NR, transmission of one or more SRs corresponding to respective radio communication services and so on in a certain period is supported. In this case, transmission of a plurality of SRs and transmission of uplink control information (UCI) using a certain PUCCH format may overlap each other. In this case, how to control the transmission of the SRs and the transmission of the UCI is a problem. If the transmission of the SRs and the UCI is not appropriately performed, communication throughput may be deteriorated or communication quality may be deteriorated.

In the light of this, the present disclosure has an object to provide a user terminal and a radio communication method that are capable of preventing deterioration of communication throughput and so on even when transmissions of uplink control information and one or more SRs overlap each other.

### Solution to Problem

A user terminal according to one aspect of the present disclosure includes: a transmitting section that transmits one or more scheduling requests; and a control section that controls transmission of the one or more scheduling requests, based on at least one of presence or absence of a configuration of a second PUCCH format, a number of configured PUCCH resource sets, and a number of scheduling request resource IDs corresponding to the one or more scheduling requests, when the one or more scheduling requests overlap uplink control information using a first PUCCH format.

### ADVANTAGEOUS EFFECTS OF INVENTION

According to one aspect of the present disclosure, deterioration of communication throughput can be prevented even when transmissions of uplink control information and one or more SRs overlap each other.

### BRIEF DESCRIPTION OF DRAWINGS

FIG. 1 is a diagram to show an example of allocation of PUCCH resources;

FIG. 2 is a diagram to show an example of a case in which transmissions of UCI and a plurality of SRs overlap each other;

FIG. 3 is a diagram to show an example of a transmission method of a case in which transmissions of UCI and a plurality of SRs overlap each other;

FIG. 4 is a diagram to show another example of a transmission method of a case in which transmissions of UCI and a plurality of SRs overlap each other;

FIG. 5 is a diagram to show an example of a schematic structure of a radio communication system according to one embodiment;

FIG. 6 is a diagram to show an example of an overall structure of a radio base station according to one embodiment;

FIG. 7 is a diagram to show an example of a functional structure of the radio base station according to one embodiment;

FIG. 8 is a diagram to show an example of an overall structure of a user terminal according to one embodiment;

FIG. 9 is a diagram to show an example of a functional structure of the user terminal according to one embodiment; and

FIG. 10 is a diagram to show an example of a hardware structure of the radio base station and the user terminal according to one embodiment.

### DESCRIPTION OF EMBODIMENTS

In future radio communication systems (for example, LTE Rel. 15 or later versions, 5G, NR and so on), a configuration (also referred to as a format, a PUCCH format (PF), and so on) for an uplink control channel (for example, a PUCCH) used for transmission of UCI has been under study. For example, in LTE Rel. 15, supporting five types of PFs, i.e., PF0 to PF4, has been under study. Note that the term “PF” used below is merely an example, and a different term may be used.

For example, PF0 and PF1 are each a PF that is used for transmission of UCI (for example, transmission confirmation information (also referred to as an HARQ-ACK (Hybrid Automatic Repeat reQuest-Acknowledge), an ACK, a NACK, or the like)) of up to 2 bits. PF0 can be allocated to 1 or 2 symbols, and is thus also referred to as a short PUCCH, a sequence-based short PUCCH, or the like. In contrast, PF1 can be allocated to 4 to 14 symbols, and is thus also referred to as a long PUCCH or the like. In PF1, a plurality of user terminals may be code-division multiplexed (CDM) in the same PRB by using block-wise spreading in the time domain with the use of at least one of a CS and an OCC.

PF2 to PF4 are each a PF that is used for transmission of UCI (for example, channel state information (CSI) (or, CSI and an HARQ-ACK and/or a scheduling request (SR))) of more than 2 bits. PF2 can be allocated to 1 or 2 symbols, and is thus also referred to as a short PUCCH and so on. In contrast, PF3 and PF4 can each be allocated to 4 to 14 symbols, and are thus each also referred to as a long PUCCH and so on. In PF4, a plurality of user terminals may be multiplexed in CDM by using block-wise spreading before DFT in the (frequency domain).

Allocation of resources (for example, PUCCH resources) used for transmission of the uplink control channel is performed by using higher layer signaling and/or downlink control information (DCI). Here, it is only necessary that the higher layer signaling be, for example, at least one of RRC (Radio Resource Control) signaling, system information (for example, at least one of RMSI (Remaining Minimum System Information), OSI (Other system information), an MIB (Master Information Block), and an SIB (System Information Block)), and broadcast information (PBCH (Physical Broadcast Channel)).

Specifically, one or more sets (PUCCH resource sets) respectively including one or more PUCCH resources are reported to (configured for) the user terminal by using the higher layer signaling. For example, K (for example, 1≤K≤4) PUCCH resource sets may be reported to the user terminal from the radio base station. Each of the PUCCH resource sets may include M (for example, 8≤M≤32) PUCCH resources.

The user terminal may determine a single PUCCH resource set out of the K configured PUCCH resource sets, based on a payload size of the UCI (UCI payload size). The UCI payload size may be the number of bits of UCI not including a cyclic redundancy check (CRC (Cyclic Redundancy Code)) bit.

The user terminal may determine a PUCCH resource to be used for transmission of the UCI out of the M PUCCH resources included in the determined PUCCH resource set, based on at least one of DCI and implicit information (also referred to as implicit indication information, an implicit index, or the like).

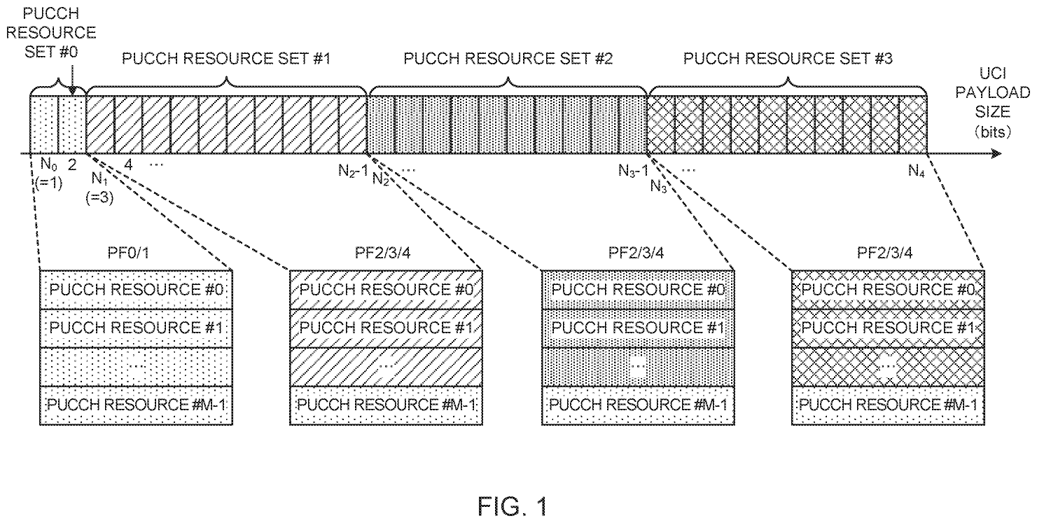

FIG. 1 is a diagram to show an example of allocation of the PUCCH resources. In FIG. 1, as an example, it is assumed that K=4, and four PUCCH resource sets #0 to #3 are configured for the user terminal from the radio base station by using the higher layer signaling. It is also assumed that each of PUCCH resource sets #0 to #3 includes M (for example, 8≤M≤32) PUCCH resources #0 to #M−1. Note that the number of PUCCH resources included in each of the PUCCH resource sets may be the same or may be different.

As shown in FIG. 1, when PUCCH resource sets #0 to #3 are configured for the user terminal, the user terminal selects any one of the PUCCH resource sets, based on the UCI payload size.

For example, when the UCI payload size is 1 or 2 bits, PUCCH resource set #0 is selected. When the UCI payload size is 3 bits or more and N₂−1 bits or less, PUCCH resource set #1 is selected. When the UCI payload size is N₂ bits or more and N₃−1 bits or less, PUCCH resource set #2 is selected. In a similar manner, when the UCI payload size is N₃ bits or more and N₃−1 bits or less, PUCCH resource set #3 is selected.

As described above, the range of the UCI payload size from which PUCCH resource set #i (i=0, K−1) is selected is indicated as Nᵢ bits or more and Nᵢ₊₁−1 bits or less (that is, {Nᵢ, Nᵢ₊₁−1} bits).

Here, the start positions (start bit numbers) N₀ and N₁ of the UCI payload size for PUCCH resource sets #0 and #1 may be 1 and 3, respectively. In this manner, PUCCH resource set #0 is selected when the UCI of up to 2 bits is transmitted, and thus PUCCH resource set #0 may include PUCCH resources #0 to #M−1 for at least one of PF0 and PF1. In contrast, any one of PUCCH resource sets #1 to #3 is selected when the UCI of more than 2 bits is transmitted, and thus each of PUCCH resource sets #1 to #3 may include PUCCH resources #0 to #M−1 for at least one of PF2, PF3, and PF4.

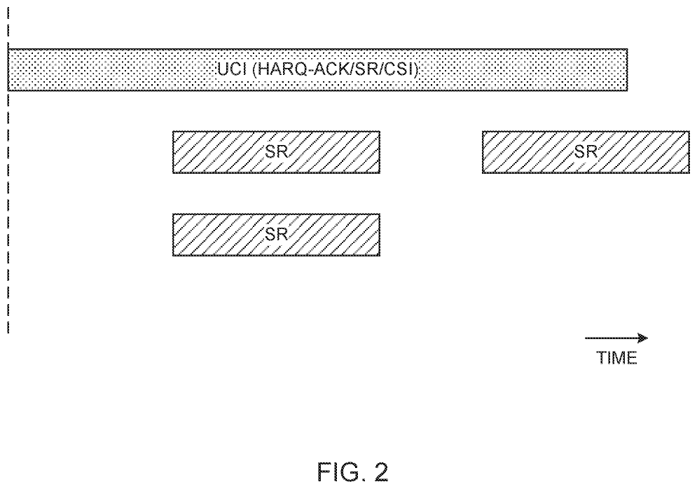

Incidentally, in NR, transmission of one or a plurality of SRs in a certain period is supported. For example, when the UE performs a scheduling request for each of the radio communication services (for example, eMBB and URLLC), the UE transmits a plurality (for example, K) SRs. In this case, transmission of the K SRs (or K SR occasions) and transmission of uplink control information (UCI) using a certain PUCCH format may overlap each other (see FIG. 2).

FIG. 2 shows a case in which UCI transmitted by using a certain PUCCH format (or a PUCCH resource) and K SRs (here, K=3) overlap each other. Note that the UCI includes at least one of an HARQ-ACK, an SR, and CSI.

In this case, how to control the transmission of the SRs and the transmission of the UCI is a problem; however, specific transmission control has not yet been fully studied.

The inventors of the present invention focused on the PF used for transmission of the SRs or the UCI, the number of overlapping SRs, and so on, and came up with the idea of controlling the transmission of the SRs and the UCI, based on at least one of presence or absence of a configuration of a certain PF, the number of configured PUCCH resource sets, and the number of SR resource IDs corresponding to the SRs.

An embodiment according to the present invention will be described below in detail with reference to the drawings. Each of aspects illustrated below may be applied individually, or may be applied in combination.

### First Aspect

In a first aspect, when one or a plurality of (one or more) SRs overlap UCI using a first PF, transmission of at least one of the SRs and the UCI is controlled based on presence or absence of a configuration of a second PF or the number of configured PUCCH resource sets. Note that the first PF may be PF0 or PF1. The second PF may be any one of PF2, PF3, and PF4.

The following description assumes a case in which a transmission period for the UCI using PF0 or PF1 and a transmission period (or an SR occasion) for a plurality of SRs overlap each other. In this case, the UE controls the transmission of the SRs and the UCI, based on the presence or absence of the configuration of the second PF and the number of configured PUCCH resource sets as follows.

<Case where Second PF is Configured>

When the second PF (for example, PF2, PF3, or PF4) is configured, UCI of more than 2 bits is transmitted, and thus the number of configured PUCCH resource sets is larger than one (any one of #1 to #3 in FIG. 1). For this reason, a case in which the second PF is configured may be interpreted as a case in which the number of configured PUCCH resource sets is larger than one.

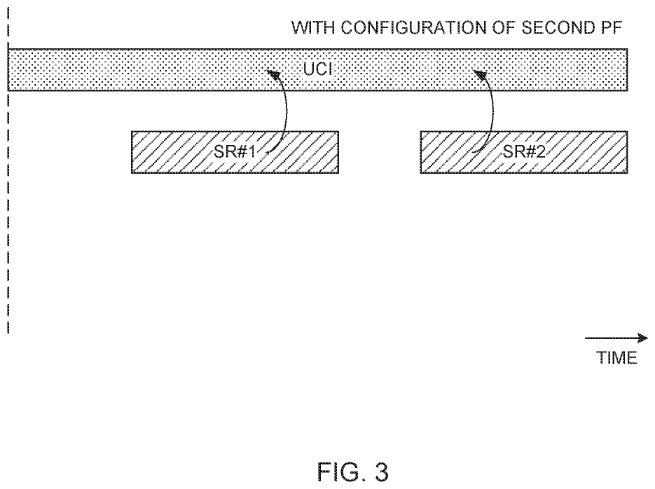

When the second PF is configured, the UE performs transmission of the UCI and the SRs (for example, a plurality of SRs) by using the second PF (see FIG. 3). FIG. 3 shows a case in which UCI and a plurality of SRs (here, SR #1 and SR #2) are transmitted by using the second PF. In this case, even when UCI transmission and SR transmission overlap each other, both of the UCI and the SRs can be transmitted to the base station.

The UE may control the transmission of the SRs, based on the number of SRs overlapping the UCI transmission. The number of SRs may be determined based on the number of SR resource IDs (for example, schedulingRequestResourceId) that are configured for the SRs. For example, the UE determines the number of SRs, based on the number of different SR resource IDs out of the SRs overlapping the UCI transmission.

The SR resource ID is a parameter configured for the UE by using a higher layer (for example, RRC signaling) and so on, and the UE determines periodicity of the SRs, a subframe offset, and so on, based on the SR resource ID. In other words, periodicity of each SR and so on may be configured for each SR resource ID, and for example, the SR resource ID may be configured for each individual communication service. For example, SR #1 and SR #2 in FIG. 3 may be SRs whose transmissions are controlled based on different SR resource IDs, or may be SRs whose transmissions are controlled based on the same SR resource ID.

When there is more than one SR resource ID that corresponds to the SRs (SR #1 and SR #2 in FIG. 3) overlapping the UCI (when there are a plurality of such SR resource ID), the UE may perform control so that the UE transmits all of the SRs. Alternatively, the UE may perform control so that the UE transmits only one or some SRs of the SRs having different SR resource IDs and does not transmit (for example, drops) the other SRs. The UE may determine the SR(s) to be transmitted, based on priority that is defined in advance. For example, priority of the SR corresponding to a certain communication service (for example, URLLC) may be configured to be high.

As described above, when the second PF having capacity larger than the first PF applied to the UCI transmission overlapped by the SRs is configured, deterioration of communication throughput can be prevented by transmitting the SRs and the UCI by using the second PF.

<Case where Second PF is not Configured>

When the second PF (for example, PF2, PF3, or PF4) is not configured, the first PF (for example, PF0 or PF1) used for transmission of the UCI of up to 2 bits is applied. When the UCI of up to 2 bits is transmitted, PUCCH resource set #0 is selected (#0 in FIG. 1). For this reason, a case in which the second PF is not configured may be interpreted as a case in which the number of configured PUCCH resource sets is one.

When the second PF is not configured, the UE performs control so that the UE performs transmission of the UCI and the SRs (for example, a plurality of SRs) by using the first PF (option 1), or so that the UE does not perform transmission of the SRs (option 2).

### [Option 1]

A case in which transmission of the UCI and the SRs is performed by using the first PF is assumed. When the first PF is PF0 (for example, when PF0 is applied to the UCI transmission), transmission of the UCI and the SRs is performed by using PF0. In this case, the transmission may be controlled according to a type of the SR (a positive SR or a negative SR) by using a cyclic shift applied to PF0.

The positive SR corresponds to an SR type that is used to indicate that UL data (for example, a UL-SCH resource) is requested. The negative SR corresponds to an SR type that is used to indicate that the UL-SCH resource is not requested.

For example, the UE may perform transmission by associating the positive SR with a certain cyclic shift value, and may perform transmission by associating the negative SR with another cyclic shift value. In this manner, the UCI and the SRs can be appropriately transmitted to the base station by using PF0.

When the first PF is PF1 (for example, PF1 is applied to UCI transmission), transmission of the UCI and the SRs is performed by using PF1. In this case, the PUCCH resource to be used for the transmission (for example, to which the UCI is allocated) may be controlled based on a type of the SR (a positive SR or a negative SR).

When the SRs (for example, all of the SRs) are negative, the UE transmits the UCI by using the PUCCH resource for the UCI (for example, an HARQ-ACK) in PF1. In contrast, when the SRs (for example, at least one or all of the SRs) are positive, the UE transmits the UCI by using the PUCCH resource for the SR corresponding to the positive SRs. Note that the PUCCH resource for the UCI and the PUCCH resource for the SR may be configured for the UE from the base station in advance.

When the UCI is transmitted on the PUCCH for the SR, the base station determines that the SRs are positive and performs scheduling of the PUSCH. In contrast, when the UCI is transmitted on the PUCCH for the UCI, the base station determines that the SRs are negative and does not perform scheduling of the PUSCH. In this manner, the base station can determine the type of the SR (positive or negative), according to the PUCCH resource used for transmission of the UCI.

When there is more than one positive SR, for example, one SR may be reported to the base station by using the PUCCH resource for the SR, and the other SRs may be dropped. Note that the SR to be reported may be selected based on priority that is configured in advance.

### [Option 2]

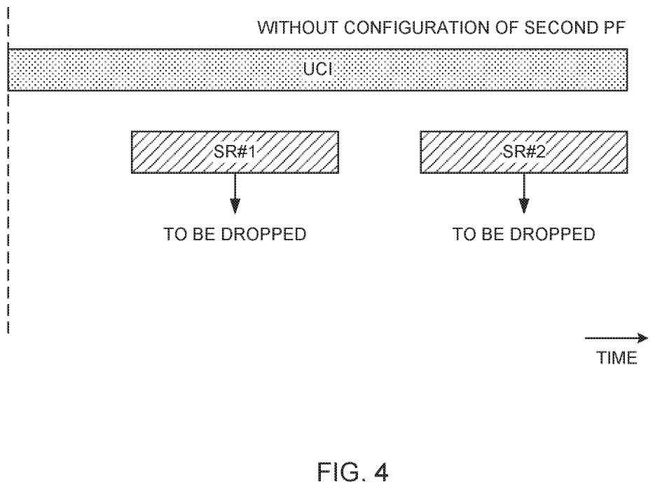

When the second PF is not configured, the UE may perform control so that the UE transmits the UCI by using the first PF (PF0 or PF1) and does not transmit (drops) the SRs (see FIG. 4). In this manner, by performing transmission of the UCI of higher priority and dropping the SRs, a processing load of the UE can be reduced.

### Second Aspect

In a second aspect, when one or a plurality of (one or more) SRs overlap UCI using the first PF, transmission of at least one of the SRs and the UCI is controlled by preferentially taking the number of SR resource IDs corresponding to the SRs into consideration.

The following description assumes a case in which a transmission period for the UCI using PF0 or PF1 and a transmission period (or an SR occasion) for a plurality of SRs overlap each other. In this case, the UE controls the transmission of the SRs and the UCI, based on the number of SR resource IDs corresponding to the SRs overlapping the UCI as follows.

<Case where Number of SR Resource IDs is One>

When the number of SR resource IDs is one, the UE performs control so that the UE performs transmission of the UCI and the SRs (for example, a plurality of SRs) by using the first PF (PF0 or PF1) (option 1), or so that the UE does not perform transmission of the SRs (option 2).

### [Option 1]

A case in which transmission of the UCI and the SRs is performed by using the first PF is assumed. When the first PF is PF0 (for example, when PF0 is applied to the UCI transmission), transmission of the UCI and the SRs is performed by using PF0. In this case, the transmission may be controlled according to a type of the SR (a positive SR or a negative SR) by using a cyclic shift applied to PF0.

For example, the UE may perform transmission by associating the positive SR with a certain cyclic shift value, and may perform transmission by associating the negative SR with another cyclic shift value. In this manner, the UCI and the SRs can be appropriately transmitted to the base station by using PF0.

When the first PF is PF1 (for example, PF1 is applied to UCI transmission), transmission of the UCI and the SRs is performed by using PF1. In this case, the PUCCH resource to be used for the transmission (for example, to which the UCI is allocated) may be controlled based on a type of the SR (a positive SR or a negative SR).

When the SRs are negative, the UE transmits the UCI by using the PUCCH resource for the UCI (for example, an HARQ-ACK) in PF1. In contrast, when the SRs are positive, the UE transmits the UCI by using the PUCCH resource for the SR corresponding to the positive SRs. Note that the PUCCH resource for the UCI and the PUCCH resource for the SR may be configured for the UE from the base station in advance.

When the UCI is transmitted on the PUCCH for the SR, the base station determines that the SRs are positive and performs scheduling of the PUSCH. In contrast, when the UCI is transmitted on the PUCCH for the UCI, the base station determines that the SRs are negative and does not perform scheduling of the PUSCH. In this manner, the base station can determine the type of the SR (positive or negative), according to the PUCCH resource used for transmission of the UCI.

### [Option 2]

When the second PF is not configured, the UE may perform control so that the UE transmits the UCI by using the first PF (PF0 or PF1) and does not transmit (drops) the SRs (see FIG. 4). In this manner, by performing transmission of the UCI of higher priority and dropping the SRs, a processing load of the UE can be reduced.

<Case where Number of SR Resource IDs is Larger than One>

When the number of SR resource IDs is larger than one, the UE controls transmission of at least one of the SRs and the UCI, based on presence or absence of a configuration of the second PF or the number of configured PUCCH resource sets.

[Case where Second PF is Configured]

When the second PF is configured, the UE performs transmission of the UCI and the SRs (for example, a plurality of SRs) by using the second PF (see FIG. 3). In this case, even when UCI transmission and SR transmission overlap each other, both of the UCI and the SRs can be transmitted to the base station. Note that a case in which the second PF is configured may be interpreted as a case in which the number of configured PUCCH resource sets is larger than one.

When the second PF having capacity larger than the first PF applied to the UCI transmission overlapped by the SRs is configured as described above, deterioration of communication throughput can be prevented by transmitting the SRs and the UCI by using the second PF.

[Case where Second PF is not Configured]

When the second PF is not configured, the UE performs control so that the UE performs transmission of the UCI and the SRs (for example, a plurality of SRs) by using the first PF (option 1), or so that the UE does not perform transmission of the SRs (option 2). Note that a case in which the second PF is not configured may be interpreted as a case in which the number of configured PUCCH resource sets is one.

### <<Option 1>>

A case in which transmission of the UCI and the SRs is performed by using the first PF is assumed. When the first PF is PF0 (for example, when PF0 is applied to the UCI transmission), transmission of the UCI and the SRs is performed by using PF0. In this case, the transmission may be controlled according to a type of the SR (a positive SR or a negative SR) by using a cyclic shift applied to PF0.

For example, the UE may perform transmission by associating the positive SR with a certain cyclic shift value, and may perform transmission by associating the negative SR with another cyclic shift value. In this manner, the UCI and the SRs can be appropriately transmitted to the base station by using PF0.

When the first PF is PF1 (for example, PF1 is applied to UCI transmission), transmission of the UCI and the SRs is performed by using PF1. In this case, the PUCCH resource to be used for the transmission (for example, to which the UCI is allocated) may be controlled based on a type of the SR (a positive SR or a negative SR).

When the SRs (for example, all of the SRs) are negative, the UE transmits the UCI by using the PUCCH resource for the UCI (for example, an HARQ-ACK) in PF1. In contrast, when the SRs (for example, at least one or all of the SRs) are positive, the UE transmits the UCI by using the PUCCH resource for the SR corresponding to the positive SRs. Note that the PUCCH resource for the UCI and the PUCCH resource for the SR may be configured for the UE from the base station in advance.

When the UCI is transmitted on the PUCCH for the SR, the base station determines that the SRs are positive and performs scheduling of the PUSCH. In contrast, when the UCI is transmitted on the PUCCH for the UCI, the base station determines that the SRs are negative and does not perform scheduling of the PUSCH. In this manner, the base station can determine the type of the SR (positive or negative), according to the PUCCH resource used for transmission of the UCI.

When there is more than one positive SR, for example, one SR may be reported to the base station by using the PUCCH resource for the SR, and the other SRs may be dropped. Note that the SR to be reported may be selected based on priority that is configured in advance.

### <<Option 2>>

When the second PF is not configured, the UE may perform control so that the UE transmits the UCI by using the first PF (PF0 or PF1) and does not transmit (drops) the SRs (see FIG. 4). In this manner, by performing transmission of the UCI of higher priority and dropping the SRs, a processing load of the UE can be reduced.

### Radio Communication System

Hereinafter, a structure of a radio communication system according to one embodiment of the present invention will be described. In this radio communication system, the radio communication method according to each embodiment of the present invention described above may be used alone or may be used in combination for communication.

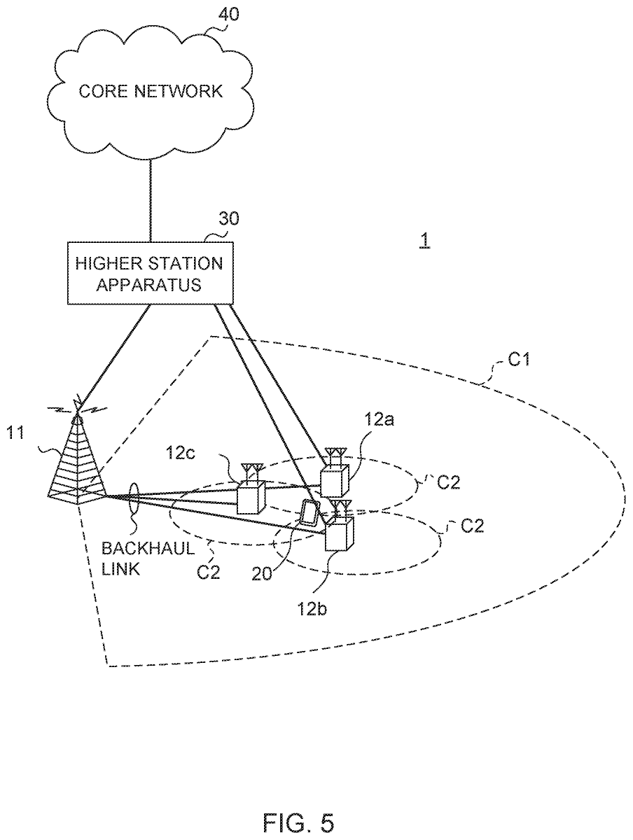

FIG. 5 is a diagram to show an example of a schematic structure of the radio communication system according to one embodiment of the present invention. A radio communication system 1 can adopt carrier aggregation (CA) and/or dual connectivity (DC) to group a plurality of fundamental frequency blocks (component carriers) into one, where the system bandwidth in an LTE system (for example, 20 MHz) constitutes one unit.

Note that the radio communication system 1 may be referred to as “LTE (Long Term Evolution),” “LTE-A (LTE-Advanced),” “LTE-B (LTE-Beyond),” “SUPER 3G,” “IMT-Advanced,” “4G (4th generation mobile communication system),” “5G (5th generation mobile communication system),” “NR (New Radio),” “FRA (Future Radio Access),” “New-RAT (Radio Access Technology),” and so on, or may be referred to as a system implementing these.

The radio communication system 1 includes a radio base station 11 that forms a macro cell C1 of a relatively wide coverage, and radio base stations 12 (12a to 12c) that form small cells C2, which are placed within the macro cell C1 and which are narrower than the macro cell C1. Also, user terminals 20 are placed in the macro cell C1 and in each small cell C2. The arrangement, the number, and the like of each cell and user terminal 20 are by no means limited to the aspect shown in the diagram.

The user terminals 20 can connect with both the radio base station 11 and the radio base stations 12. It is assumed that the user terminals 20 use the macro cell C1 and the small cells C2 at the same time by means of CA or DC. The user terminals 20 may adopt CA or DC by using a plurality of cells (CCs) (for example, five or less CCs, or six or more CCs).

Between the user terminals 20 and the radio base station 11, communication can be carried out by using a carrier of a relatively low frequency band (for example, 2 GHz) and a narrow bandwidth (referred to as, for example, an “existing carrier,” a “legacy carrier” and so on). Meanwhile, between the user terminals 20 and the radio base stations 12, a carrier of a relatively high frequency band (for example, 3.5 GHz, 5 GHz, and so on) and a wide bandwidth may be used, or the same carrier as that used between the user terminals 20 and the radio base station 11 may be used. Note that the structure of the frequency band for use in each radio base station is by no means limited to these.

The user terminals 20 can perform communication by using time division duplex (TDD) and/or frequency division duplex (FDD) in each cell. Furthermore, in each cell (carrier), a single numerology may be employed, or a plurality of different numerologies may be employed.

A wired connection (for example, an X2 interface and an optical fiber in compliance with the CPRI (Common Public Radio Interface) and so on) or a wireless connection may be established between the radio base station 11 and the radio base stations 12 (or between two radio base stations 12).

The radio base station 11 and the radio base stations 12 are each connected with a higher station apparatus 30, and are connected with a core network 40 via the higher station apparatus 30. Note that the higher station apparatus 30 may be, for example, access gateway apparatus, a radio network controller (RNC), a mobility management entity (MME) and so on, but is by no means limited to these. Also, each radio base station 12 may be connected with the higher station apparatus 30 via the radio base station 11.

Note that the radio base station 11 is a radio base station having a relatively wide coverage, and may be referred to as a “macro base station,” a “central node,” an “eNB (eNodeB),” a “transmitting/receiving point” and so on. The radio base stations 12 are radio base stations having local coverages, and may be referred to as “small base stations,” “micro base stations,” “pico base stations,” “femto base stations,” “HeNBs (Home eNodeBs),” “RRHs (Remote Radio Heads),” “transmitting/receiving points” and so on. Hereinafter, the radio base stations 11 and 12 will be collectively referred to as “radio base stations 10,” when the radio base stations 11 and 12 are not distinguished.

Each of the user terminals 20 is a terminal that supports various communication schemes such as LTE and LTE-A, and may include not only mobile communication terminals (mobile stations) but stationary communication terminals (fixed stations).

In the radio communication system 1, as radio access schemes, orthogonal frequency division multiple access (OFDMA) is applied to the downlink, and single carrier frequency division multiple access (SC-FDMA) and/or OFDMA is applied to the uplink.

OFDMA is a multi-carrier communication scheme to perform communication by dividing a frequency band into a plurality of narrow frequency bands (subcarriers) and mapping data to each subcarrier. SC-FDMA is a single carrier communication scheme to mitigate interference between terminals by dividing the system bandwidth into bands formed with one or continuous resource blocks per terminal, and allowing a plurality of terminals to use mutually different bands. Note that the uplink and downlink radio access schemes are by no means limited to the combinations of these, and other radio access schemes may be used.

In the radio communication system 1, a downlink shared channel (PDSCH (Physical Downlink Shared Channel), which is used by each user terminal 20 on a shared basis, a broadcast channel (PBCH (Physical Broadcast Channel)), downlink L1/L2 control channels and so on, are used as downlink channels. User data, higher layer control information, SIBs (System Information Blocks) and so on are communicated on the PDSCH. The MIBs (Master Information Blocks) are communicated on the PBCH.

The downlink L1/L2 control channels include a PDCCH (Physical Downlink Control Channel), an EPDCCH (Enhanced Physical Downlink Control Channel), a PCFICH (Physical Control Format Indicator Channel), a PHICH (Physical Hybrid-ARQ Indicator Channel) and so on. Downlink control information (DCI), including PDSCH and/or PUSCH scheduling information, and so on are communicated on the PDCCH.

Note that the scheduling information may be reported by the DCI. For example, the DCI scheduling DL data reception may be referred to as “DL assignment,” and the DCI scheduling UL data transmission may be referred to as “UL grant.”

The number of OFDM symbols to use for the PDCCH is communicated on the PCFICH. Transmission confirmation information (for example, also referred to as “retransmission control information,” “HARQ-ACK,” “ACK/NACK,” and so on) of HARQ (Hybrid Automatic Repeat reQuest) to a PUSCH is transmitted on the PHICH. The EPDCCH is frequency-division multiplexed with the PDSCH (downlink shared data channel) and used to communicate DCI and so on, like the PDCCH.

In the radio communication system 1, an uplink shared channel (PUSCH (Physical Uplink Shared Channel)), which is used by each user terminal 20 on a shared basis, an uplink control channel (PUCCH (Physical Uplink Control Channel)), a random access channel (PRACH (Physical Random Access Channel)) and so on are used as uplink channels. User data, higher layer control information and so on are communicated on the PUSCH. In addition, radio quality information (CQI (Channel Quality Indicator)) of the downlink, transmission confirmation information, a scheduling request (SR), and so on are transmitted on the PUCCH. By means of the PRACH, random access preambles for establishing connections with cells are communicated.

In the radio communication system 1, a cell-specific reference signal (CRS), a channel state information-reference signal (CSI-RS), a demodulation reference signal (DMRS), a positioning reference signal (PRS), and so on are transmitted as downlink reference signals. In the radio communication system 1, a measurement reference signal (SRS (Sounding Reference Signal)), a demodulation reference signal (DMRS), and so on are transmitted as uplink reference signals. Note that DMRS may be referred to as a “user terminal specific reference signal (UE-specific Reference Signal).” Transmitted reference signals are by no means limited to these.

### Radio Base Station

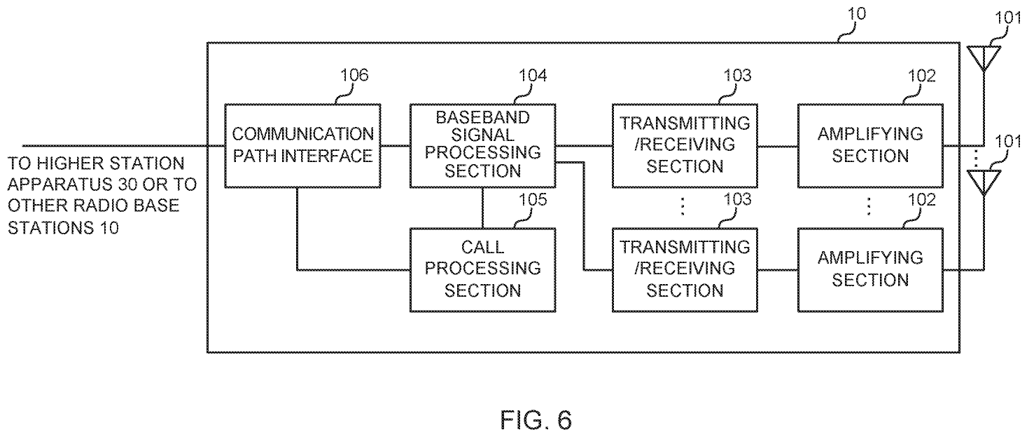

FIG. 6 is a diagram to show an example of an overall structure of the radio base station according to one embodiment of the present invention. A radio base station 10 includes a plurality of transmitting/receiving antennas 101, amplifying sections 102, transmitting/receiving sections 103, a baseband signal processing section 104, a call processing section 105 and a communication path interface 106. Note that the radio base station 10 may be configured to include one or more transmitting/receiving antennas 101, one or more amplifying sections 102 and one or more transmitting/receiving sections 103.

User data to be transmitted from the radio base station 10 to the user terminal 20 by the downlink is input from the higher station apparatus 30 to the baseband signal processing section 104, via the communication path interface 106.

In the baseband signal processing section 104, the user data is subjected to transmission processes, such as a PDCP (Packet Data Convergence Protocol) layer process, division and coupling of the user data, RLC (Radio Link Control) layer transmission processes such as RLC retransmission control, MAC (Medium Access Control) retransmission control (for example, an HARQ transmission process), scheduling, transport format selection, channel coding, an inverse fast Fourier transform (IFFT) process, and a precoding process, and the result is forwarded to each transmitting/receiving section 103. Furthermore, downlink control signals are also subjected to transmission processes such as channel coding and inverse fast Fourier transform, and the result is forwarded to the transmitting/receiving sections 103.

The transmitting/receiving sections 103 convert baseband signals that are pre-coded and output from the baseband signal processing section 104 on a per antenna basis, to have radio frequency bands and transmit the result. The radio frequency signals having been subjected to frequency conversion in the transmitting/receiving sections 103 are amplified in the amplifying sections 102, and transmitted from the transmitting/receiving antennas 101. The transmitting/receiving sections 103 can be constituted with transmitters/receivers, transmitting/receiving circuits or transmitting/receiving apparatus that can be described based on general understanding of the technical field to which the present invention pertains. Note that each transmitting/receiving section 103 may be structured as a transmitting/receiving section in one entity, or may be constituted with a transmitting section and a receiving section.

Meanwhile, as for uplink signals, radio frequency signals that are received in the transmitting/receiving antennas 101 are amplified in the amplifying sections 102. The transmitting/receiving sections 103 receive the uplink signals amplified in the amplifying sections 102. The transmitting/receiving sections 103 convert the received signals into the baseband signal through frequency conversion and outputs to the baseband signal processing section 104.

In the baseband signal processing section 104, user data that is included in the uplink signals that are input is subjected to a fast Fourier transform (FFT) process, an inverse discrete Fourier transform (IDFT) process, error correction decoding, a MAC retransmission control receiving process, and RLC layer and PDCP layer receiving processes, and forwarded to the higher station apparatus 30 via the communication path interface 106. The call processing section 105 performs call processing (setting up, releasing and so on) for communication channels, manages the state of the radio base station 10, manages the radio resources and so on.

The communication path interface 106 transmits and/or receives signals to and/or from the higher station apparatus 30 via a certain interface. The communication path interface 106 may transmit and/or receive signals (backhaul signaling) with other radio base stations 10 via an inter-base station interface (for example, an X2 interface and an optical fiber in compliance with the CPRI (Common Public Radio Interface)).

Each of the transmitting/receiving sections 103 receives one or more scheduling requests. Further, each of the transmitting/receiving sections 103 transmits information related to the SR resource ID to the UE by using a higher layer (for example, RRC signaling).

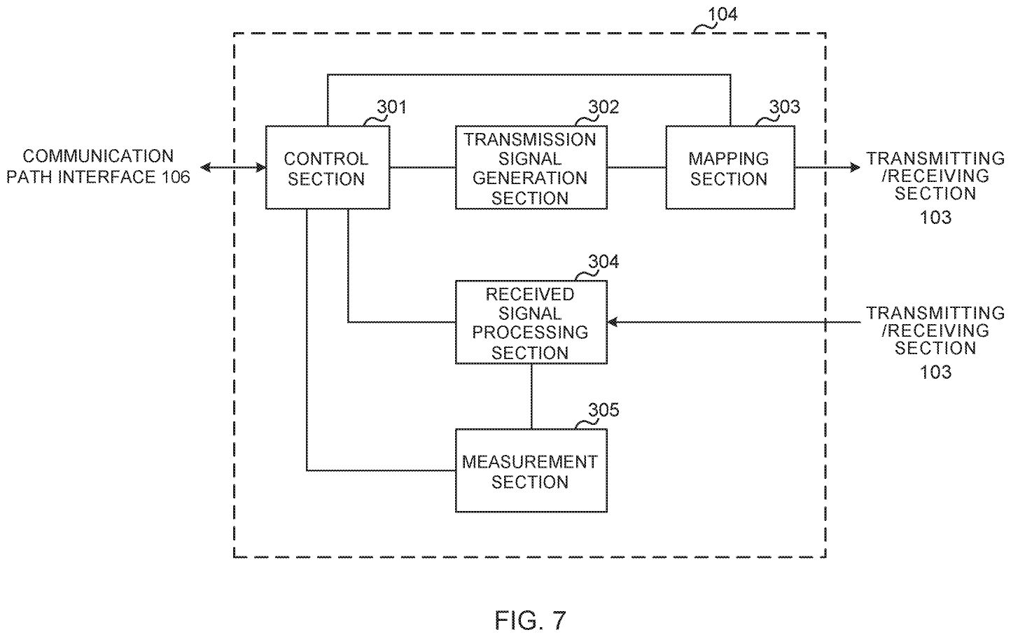

FIG. 7 is a diagram to show an example of a functional structure of the radio base station according to one embodiment of the present invention. Note that, the present example primarily shows functional blocks that pertain to characteristic parts of the present embodiment, and it is assumed that the radio base station 10 may include other functional blocks that are necessary for radio communication as well.

The baseband signal processing section 104 at least includes a control section (scheduler) 301, a transmission signal generation section 302, a mapping section 303, a received signal processing section 304, and a measurement section 305. Note that these structures may be included in the radio base station 10, and some or all of the structures do not need to be included in the baseband signal processing section 104.

The control section (scheduler) 301 controls the whole of the radio base station 10. The control section 301 can be constituted with a controller, a control circuit or control apparatus that can be described based on general understanding of the technical field to which the present invention pertains.

The control section 301, for example, controls the generation of signals in the transmission signal generation section 302, the mapping of signals by the mapping section 303, and so on. The control section 301 controls the signal receiving processes in the received signal processing section 304, the measurements of signals in the measurement section 305, and so on.

The control section 301 controls scheduling (for example, resource allocation) of system information, a downlink data signal (for example, a signal transmitted on a PDSCH), and a downlink control signal (for example, a signal transmitted on a PDCCH and/or an EPDCCH, transmission confirmation information, and so on). Based on the results of determining necessity or not of retransmission control to the uplink data signal, or the like, the control section 301 controls generation of a downlink control signal, a downlink data signal, and so on. The control section 301 controls the scheduling of a synchronization signal (for example, a PSS (Primary Synchronization Signal)/an SSS (Secondary Synchronization Signal)), a downlink reference signal (for example, a CRS, a CSI-RS, a DMRS), and so on.

The control section 301 controls scheduling of an uplink data signal (for example, a signal transmitted on the PUSCH), an uplink control signal (for example, a signal transmitted on the PUCCH and/or the PUSCH, transmission confirmation information, and so on), a random access preamble (for example, a signal transmitted on the PRACH), an uplink reference signal, and so on.

When the SRs transmitted from the UE overlap the UCI using the first PF, the control section 301 may control reception of the SRs, based on at least one of presence or absence of a configuration of the second PF, the number of configured PUCCH resource sets, and the number of SR resource IDs.

The transmission signal generation section 302 generates downlink signals (downlink control signals, downlink data signals, downlink reference signals and so on) based on commands from the control section 301 and outputs the downlink signals to the mapping section 303. The transmission signal generation section 302 can be constituted with a signal generator, a signal generation circuit or signal generation apparatus that can be described based on general understanding of the technical field to which the present invention pertains.

For example, the transmission signal generation section 302 generates DL assignment to report assignment information of downlink data and/or UL grant to report assignment information of uplink data, based on commands from the control section 301. The DL assignment and the UL grant are both DCI, and follow the DCI format. For a downlink data signal, encoding processing and modulation processing are performed in accordance with a coding rate, modulation scheme, or the like determined based on channel state information (CSI) from each user terminal 20.

The mapping section 303 maps the downlink signals generated in the transmission signal generation section 302 to certain radio resources, based on commands from the control section 301, and outputs these to the transmitting/receiving sections 103. The mapping section 303 can be constituted with a mapper, a mapping circuit or mapping apparatus that can be described based on general understanding of the technical field to which the present invention pertains.

The received signal processing section 304 performs receiving processes (for example, demapping, demodulation, decoding and so on) of received signals that are input from the transmitting/receiving sections 103. Here, the received signals are, for example, uplink signals that are transmitted from the user terminals 20 (uplink control signals, uplink data signals, uplink reference signals and so on). The received signal processing section 304 can be constituted with a signal processor, a signal processing circuit or signal processing apparatus that can be described based on general understanding of the technical field to which the present invention pertains.

The received signal processing section 304 outputs the decoded information acquired through the receiving processes to the control section 301. For example, if the received signal processing section 304 receives the PUCCH including HARQ-ACK, the received signal processing section 304 outputs the HARQ-ACK to the control section 301. The received signal processing section 304 outputs the received signals and/or the signals after the receiving processes to the measurement section 305.

The measurement section 305 conducts measurements with respect to the received signals. The measurement section 305 can be constituted with a measurer, a measurement circuit or measurement apparatus that can be described based on general understanding of the technical field to which the present invention pertains.

For example, the measurement section 305 may perform RRM (Radio Resource Management) measurement, CSI (Channel State Information) measurement, and so on, based on the received signal. The measurement section 305 may measure a received power (for example, RSRP (Reference Signal Received Power)), a received quality (for example, RSRQ (Reference Signal Received Quality), an SINR (Signal to Interference plus Noise Ratio), an SNR (Signal to Noise Ratio)), a signal strength (for example, RSSI (Received Signal Strength Indicator)), channel information (for example, CSI), and so on. The measurement results may be output to the control section 301.

### User Terminal

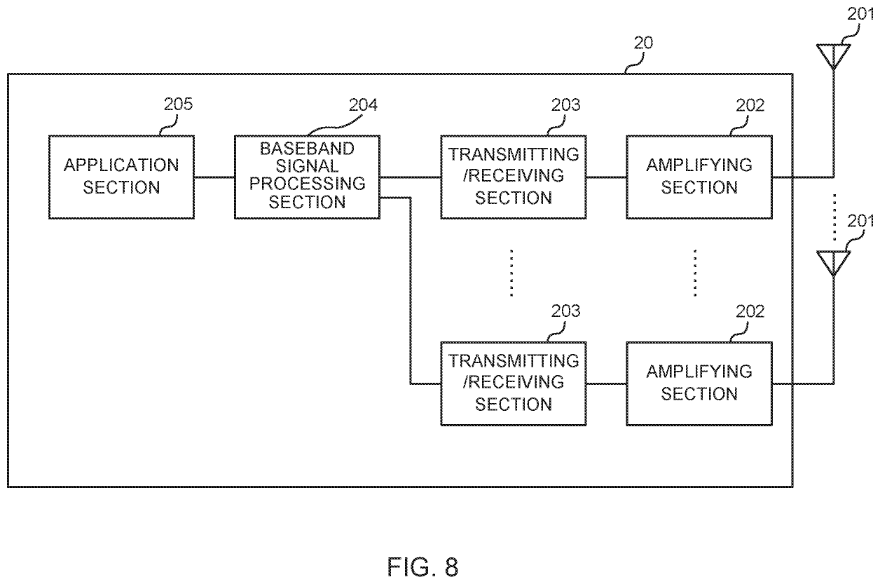

FIG. 8 is a diagram to show an example of an overall structure of a user terminal according to one embodiment of the present invention. A user terminal 20 includes a plurality of transmitting/receiving antennas 201, amplifying sections 202, transmitting/receiving sections 203, a baseband signal processing section 204 and an application section 205. Note that the user terminal 20 may be configured to include one or more transmitting/receiving antennas 201, one or more amplifying sections 202 and one or more transmitting/receiving sections 203.

Radio frequency signals that are received in the transmitting/receiving antennas 201 are amplified in the amplifying sections 202. The transmitting/receiving sections 203 receive the downlink signals amplified in the amplifying sections 202. The transmitting/receiving sections 203 convert the received signals into baseband signals through frequency conversion, and output the baseband signals to the baseband signal processing section 204. The transmitting/receiving sections 203 can be constituted with transmitters/receivers, transmitting/receiving circuits or transmitting/receiving apparatus that can be described based on general understanding of the technical field to which the present invention pertains. Note that each transmitting/receiving section 203 may be structured as a transmitting/receiving section in one entity, or may be constituted with a transmitting section and a receiving section.

The baseband signal processing section 204 performs, on each input baseband signal, an FFT process, error correction decoding, a retransmission control receiving process, and so on. The downlink user data is forwarded to the application section 205. The application section 205 performs processes related to higher layers above the physical layer and the MAC layer, and so on. In the downlink data, broadcast information may be also forwarded to the application section 205.

Meanwhile, the uplink user data is input from the application section 205 to the baseband signal processing section 204. The baseband signal processing section 204 performs a retransmission control transmission process (for example, an HARQ transmission process), channel coding, precoding, a discrete Fourier transform (DFT) process, an IFFT process and so on, and the result is forwarded to the transmitting/receiving section 203. The transmitting/receiving sections 203 convert the baseband signals output from the baseband signal processing section 204 to have radio frequency band and transmit the result. The radio frequency signals having been subjected to frequency conversion in the transmitting/receiving sections 203 are amplified in the amplifying sections 202, and transmitted from the transmitting/receiving antennas 201.

The transmitting/receiving sections 203 transmit one or more scheduling requests. The transmitting/receiving sections 203 may receive information related to the SR resource ID transmitted by using a higher layer (for example, RRC signaling).

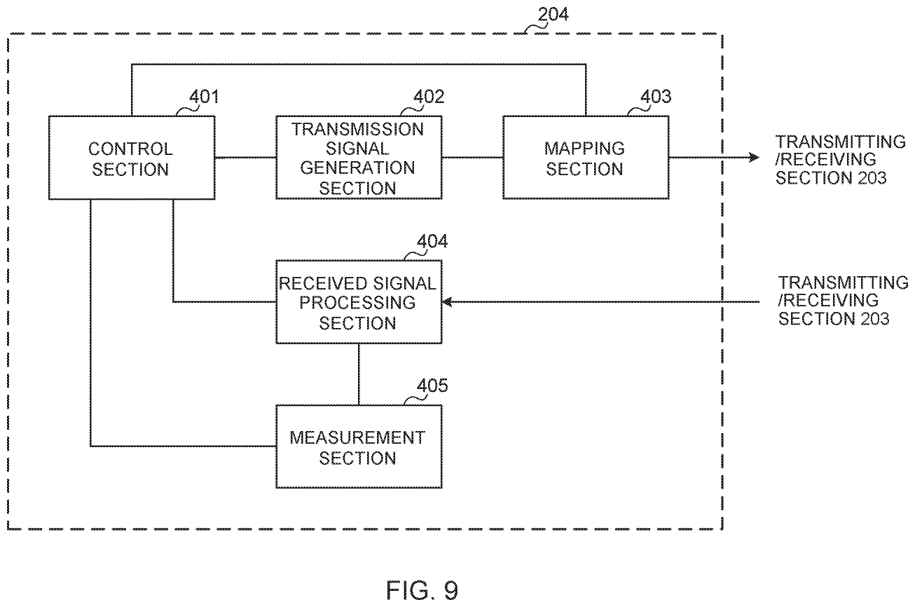

FIG. 9 is a diagram to show an example of a functional structure of a user terminal according to one embodiment of the present invention. Note that, the present example primarily shows functional blocks that pertain to characteristic parts of the present embodiment, and it is assumed that the user terminal 20 may include other functional blocks that are necessary for radio communication as well.

The baseband signal processing section 204 provided in the user terminal 20 at least includes a control section 401, a transmission signal generation section 402, a mapping section 403, a received signal processing section 404 and a measurement section 405. Note that these structures may be included in the user terminal 20, and some or all of the structures do not need to be included in the baseband signal processing section 204.

The control section 401 controls the whole of the user terminal 20. The control section 401 can be constituted with a controller, a control circuit or control apparatus that can be described based on general understanding of the technical field to which the present invention pertains.

The control section 401, for example, controls the generation of signals in the transmission signal generation section 402, the mapping of signals by the mapping section 403, and so on. The control section 401 controls the signal receiving processes in the received signal processing section 404, the measurements of signals in the measurement section 405, and so on.

The control section 401 acquires a downlink control signal and a downlink data signal transmitted from the radio base station 10, from the received signal processing section 404. The control section 401 controls generation of an uplink control signal and/or an uplink data signal, based on the results of determining necessity or not of retransmission control to a downlink control signal and/or a downlink data signal.

When the scheduling requests overlap the uplink control information using the first PUCCH format, the control section 401 controls transmission of the scheduling requests, based on at least one of presence or absence of a configuration of the second PUCCH format, the number of configured PUCCH resource sets, and the number of scheduling request resource IDs corresponding to the scheduling requests.

For example, when the second PUCCH format is configured or when the number of configured PUCCH resource sets is larger than one, the control section 401 may perform control so that the scheduling requests and the uplink control information are transmitted by using the second PUCCH format. Alternatively, when the second PUCCH format is not configured or when the number of configured PUCCH resource sets is one, the control section 401 may determine a resource to be used for transmission of the uplink control information, based on a type of the scheduling requests.

When the number of scheduling request resource IDs corresponding to the scheduling requests is one, the control section 401 may determine a resource to be used for transmission of the uplink control information, based on a type of the scheduling requests. When the number of scheduling request resource IDs corresponding to the scheduling requests is larger than one, the control section 401 may control transmission of the scheduling requests, based on presence or absence of the configuration of the second PUCCH format or the number of the configured PUCCH resource sets.

The transmission signal generation section 402 generates uplink signals (uplink control signals, uplink data signals, uplink reference signals and so on) based on commands from the control section 401, and outputs the uplink signals to the mapping section 403. The transmission signal generation section 402 can be constituted with a signal generator, a signal generation circuit or signal generation apparatus that can be described based on general understanding of the technical field to which the present invention pertains.

For example, the transmission signal generation section 402 generates an uplink control signal about transmission confirmation information, the channel state information (CSI), and so on, based on commands from the control section 401. The transmission signal generation section 402 generates uplink data signals, based on commands from the control section 401. For example, when a UL grant is included in a downlink control signal that is reported from the radio base station 10, the control section 401 commands the transmission signal generation section 402 to generate the uplink data signal.

The mapping section 403 maps the uplink signals generated in the transmission signal generation section 402 to radio resources, based on commands from the control section 401, and outputs the result to the transmitting/receiving sections 203. The mapping section 403 can be constituted with a mapper, a mapping circuit or mapping apparatus that can be described based on general understanding of the technical field to which the present invention pertains.

The received signal processing section 404 performs receiving processes (for example, demapping, demodulation, decoding and so on) of received signals that are input from the transmitting/receiving sections 203. Here, the received signals are, for example, downlink signals transmitted from the radio base station 10 (downlink control signals, downlink data signals, downlink reference signals and so on). The received signal processing section 404 can be constituted with a signal processor, a signal processing circuit or signal processing apparatus that can be described based on general understanding of the technical field to which the present invention pertains. The received signal processing section 404 can constitute the receiving section according to the present invention.

The received signal processing section 404 outputs the decoded information acquired through the receiving processes to the control section 401. The received signal processing section 404 outputs, for example, broadcast information, system information, RRC signaling, DCI and so on, to the control section 401. The received signal processing section 404 outputs the received signals and/or the signals after the receiving processes to the measurement section 405.

The measurement section 405 conducts measurements with respect to the received signals. The measurement section 405 can be constituted with a measurer, a measurement circuit or measurement apparatus that can be described based on general understanding of the technical field to which the present invention pertains.

For example, the measurement section 405 may perform RRM measurement, CSI measurement, and so on, based on the received signal. The measurement section 405 may measure a received power (for example, RSRP), a received quality (for example, RSRQ, SINR, SNR), a signal strength (for example, RSSI), channel information (for example, CSI), and so on. The measurement results may be output to the control section 401.

### Hardware Structure

Note that the block diagrams that have been used to describe the above embodiments show blocks in functional units. These functional blocks (components) may be implemented in arbitrary combinations of hardware and/or software. Also, the method for implementing each functional block is not particularly limited. That is, each functional block may be realized by one piece of apparatus that is physically and/or logically aggregated, or may be realized by directly and/or indirectly connecting two or more physically and/or logically separate pieces of apparatus (via wire and/or wireless, for example) and using these plurality of pieces of apparatus.

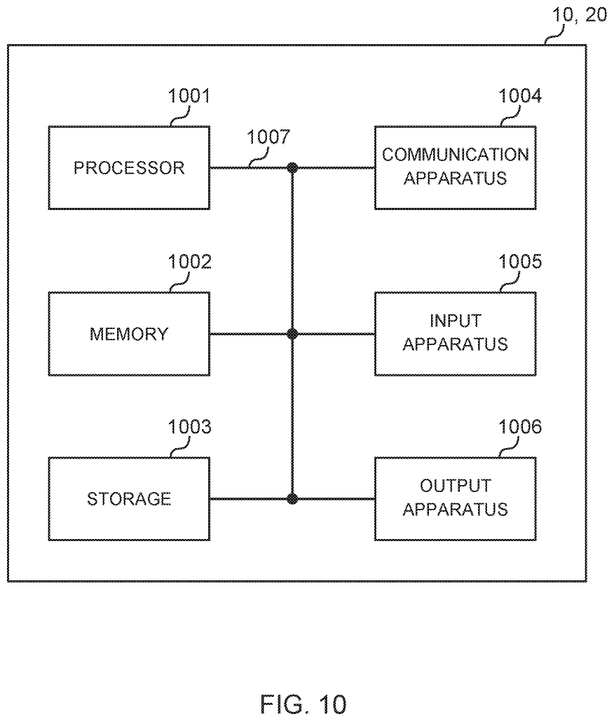

For example, a radio base station, a user terminal, and so on according to one embodiment of the present invention may function as a computer that executes the processes of the radio communication method of the present invention. FIG. 10 is a diagram to show an example of a hardware structure of the radio base station and the user terminal according to one embodiment of the present invention. Physically, the above-described radio base station 10 and user terminals 20 may each be formed as computer apparatus that includes a processor 1001, a memory 1002, a storage 1003, a communication apparatus 1004, an input apparatus 1005, an output apparatus 1006, a bus 1007, and so on.

Note that, in the following description, the word “apparatus” may be interpreted as “circuit,” “device,” “unit,” and so on. The hardware structure of the radio base station 10 and the user terminals 20 may be designed to include one or a plurality of apparatuses shown in the drawings, or may be designed not to include part of pieces of apparatus.

For example, although only one processor 1001 is shown, a plurality of processors may be provided. Furthermore, processes may be implemented with one processor or may be implemented at the same time, in sequence, or in different manners with one or more processors. Note that the processor 1001 may be implemented with one or more chips.

Each function of the radio base station 10 and the user terminals 20 is implemented, for example, by allowing certain software (programs) to be read on hardware such as the processor 1001 and the memory 1002, and by allowing the processor 1001 to perform calculations to control communication via the communication apparatus 1004 and control reading and/or writing of data in the memory 1002 and the storage 1003.

The processor 1001 controls the whole computer by, for example, running an operating system. The processor 1001 may be configured with a central processing unit (CPU), which includes interfaces with peripheral apparatus, control apparatus, computing apparatus, a register, and so on. For example, the above-described baseband signal processing section 104 (204), call processing section 105, and so on may be implemented by the processor 1001.

Furthermore, the processor 1001 reads programs (program codes), software modules, data, and so on from the storage 1003 and/or the communication apparatus 1004, into the memory 1002, and executes various processes according to these. As for the programs, programs to allow computers to execute at least part of the operations of the above-described embodiments are used. For example, the control section 401 of each user terminal 20 may be implemented by control programs that are stored in the memory 1002 and that operate on the processor 1001, and other functional blocks may be implemented likewise.

The memory 1002 is a computer-readable recording medium, and may be constituted with, for example, at least one of a ROM (Read Only Memory), an EPROM (Erasable Programmable ROM), an EEPROM (Electrically EPROM), a RAM (Random Access Memory), and other appropriate storage media. The memory 1002 may be referred to as a “register,” a “cache,” a “main memory (primary storage apparatus)” and so on. The memory 1002 can store executable programs (program codes), software modules, and the like for implementing the radio communication method according to one embodiment of the present invention.

The storage 1003 is a computer-readable recording medium, and may be constituted with, for example, at least one of a flexible disk, a floppy (registered trademark) disk, a magneto-optical disk (for example, a compact disc (CD-ROM (Compact Disc ROM) and so on), a digital versatile disc, a Blu-ray (registered trademark) disk), a removable disk, a hard disk drive, a smart card, a flash memory device (for example, a card, a stick, and a key drive), a magnetic stripe, a database, a server, and other appropriate storage media. The storage 1003 may be referred to as “secondary storage apparatus.”

The communication apparatus 1004 is hardware (transmitting/receiving device) for allowing inter-computer communication via a wired and/or wireless network, and may be referred to as, for example, a “network device,” a “network controller,” a “network card,” a “communication module,” and so on. The communication apparatus 1004 may be configured to include a high frequency switch, a duplexer, a filter, a frequency synthesizer, and so on in order to realize, for example, frequency division duplex (FDD) and/or time division duplex (TDD). For example, the above-described transmitting/receiving antennas 101 (201), amplifying sections 102 (202), transmitting/receiving sections 103 (203), communication path interface 106, and so on may be implemented by the communication apparatus 1004.

The input apparatus 1005 is an input device that receives input from the outside (for example, a keyboard, a mouse, a microphone, a switch, a button, a sensor, and so on). The output apparatus 1006 is an output device that allows sending output to the outside (for example, a display, a speaker, an LED (Light Emitting Diode) lamp, and so on). Note that the input apparatus 1005 and the output apparatus 1006 may be provided in an integrated structure (for example, a touch panel).

Furthermore, these types of apparatus, including the processor 1001, the memory 1002, and others, are connected by a bus 1007 for communicating information. The bus 1007 may be formed with a single bus, or may be formed with buses that vary between pieces of apparatus.

Also, the radio base station 10 and the user terminals 20 may be structured to include hardware such as a microprocessor, a digital signal processor (DSP), an ASIC (Application Specific Integrated Circuit), a PLD (Programmable Logic Device), an FPGA (Field Programmable Gate Array), and so on, and part or all of the functional blocks may be implemented by the hardware. For example, the processor 1001 may be implemented with at least one of these pieces of hardware.

### Variations

Note that the terminology described in this specification and/or the terminology that is needed to understand this specification may be replaced by other terms that convey the same or similar meanings. For example, “channels” and/or “symbols” may be “signals” (“signaling”). Also, “signals” may be “messages.” A reference signal may be abbreviated as an “RS,” and may be referred to as a “pilot,” a “pilot signal,” and so on, depending on which standard applies. Furthermore, a “component carrier (CC)” may be referred to as a “cell,” a “frequency carrier,” a “carrier frequency” and so on.

A radio frame may be constituted of one or a plurality of periods (frames) in the time domain. Each of one or a plurality of periods (frames) constituting a radio frame may be referred to as a “subframe.” Furthermore, a subframe may be constituted of one or a plurality of slots in the time domain. A subframe may be a fixed time length (for example, 1 ms) independent of numerology.

Furthermore, a slot may be constituted of one or a plurality of symbols in the time domain (OFDM (Orthogonal Frequency Division Multiplexing) symbols, SC-FDMA (Single Carrier Frequency Division Multiple Access) symbols, and so on). Furthermore, a slot may be a time unit based on numerology. A slot may include a plurality of mini-slots. Each mini-slot may be constituted of one or a plurality of symbols in the time domain. A mini-slot may be referred to as a “sub-slot.”

A radio frame, a subframe, a slot, a mini-slot, and a symbol all express time units in signal communication. A radio frame, a subframe, a slot, a mini-slot, and a symbol may each be called by other applicable terms. For example, one subframe may be referred to as a “transmission time interval (TTI),” a plurality of consecutive subframes may be referred to as a “TTI” or one slot or one mini-slot may be referred to as a “TTI.” That is, a subframe and/or a TTI may be a subframe (1 ms) in existing LTE, may be a shorter period than 1 ms (for example, 1 to 13 symbols), or may be a longer period than 1 ms. Note that a unit expressing TTI may be referred to as a “slot,” a “mini-slot,” and so on instead of a “subframe.”

Here, a TTI refers to the minimum time unit of scheduling in radio communication, for example. For example, in LTE systems, a radio base station schedules the allocation of radio resources (such as a frequency bandwidth and transmission power that are available for each user terminal) for the user terminal in TTI units. Note that the definition of TTIs is not limited to this.

TTIs may be transmission time units for channel-encoded data packets (transport blocks), code blocks, and/or codewords, or may be the unit of processing in scheduling, link adaptation, and so on. Note that, when TTIs are given, the time interval (for example, the number of symbols) to which transport blocks, code blocks, and/or codewords are actually mapped may be shorter than the TTIs.

Note that, in the case where one slot or one mini-slot is referred to as a TTI, one or more TTIs (that is, one or more slots or one or more mini-slots) may be the minimum time unit of scheduling. Furthermore, the number of slots (the number of mini-slots) constituting the minimum time unit of the scheduling may be controlled.

A TTI having a time length of 1 ms may be referred to as a “usual TTI” (TTI in LTE Rel. 8 to Rel. 12), a “normal TTI,” a “long TTI,” a “usual subframe,” a “normal subframe,” a “long subframe” and so on. A TTI that is shorter than a usual TTI may be referred to as a “shortened TTI,” a “short TTI,” a “partial or fractional TTI,” a “shortened subframe,” a “short subframe,” a “mini-slot,” a “sub-slot” and so on.

Note that a long TTI (for example, a usual TTI, a subframe, and so on) may be interpreted as a TTI having a time length exceeding 1 ms, and a short TTI (for example, a shortened TTI and so on) may be interpreted as a TTI having a TTI length shorter than the TTI length of a long TTI and equal to or longer than 1 ms.

A resource block (RB) is the unit of resource allocation in the time domain and the frequency domain, and may include one or a plurality of consecutive subcarriers in the frequency domain. Also, an RB may include one or a plurality of symbols in the time domain, and may be one slot, one mini-slot, one subframe, or one TTI in length. One TTI and one subframe each may be constituted of one or a plurality of resource blocks. Note that one or a plurality of RBs may be referred to as a “physical resource block (PRB (Physical RB)),” a “sub-carrier group (SCG),” a “resource element group (REG),”a “PRB pair,” an “RB pair” and so on.

Furthermore, a resource block may be constituted of one or a plurality of resource elements (REs). For example, one RE may correspond to a radio resource field of one subcarrier and one symbol.

Note that the above-described structures of radio frames, subframes, slots, mini-slots, symbols, and so on are merely examples. For example, structures such as the number of subframes included in a radio frame, the number of slots per subframe or radio frame, the number of mini-slots included in a slot, the numbers of symbols and RBs included in a slot or a mini-slot, the number of subcarriers included in an RB, the number of symbols in a TTI, the symbol length, the cyclic prefix (CP) length, and so on can be variously changed.

Also, the information, parameters, and so on described in this specification may be represented in absolute values or in relative values with respect to certain values, or may be represented in another corresponding information. For example, radio resources may be specified by certain indices.

The names used for parameters and so on in this specification are in no respect limiting. For example, since various channels (PUCCH (Physical Uplink Control Channel), PDCCH (Physical Downlink Control Channel), and so on) and information elements can be identified by any suitable names, the various names allocated to these various channels and information elements are in no respect limiting.

The information, signals, and so on described in this specification may be represented by using any of a variety of different technologies. For example, data, instructions, commands, information, signals, bits, symbols, chips, and so on, all of which may be referenced throughout the herein-contained description, may be represented by voltages, currents, electromagnetic waves, magnetic fields or particles, optical fields or photons, or any combination of these.

Also, information, signals, and so on can be output from higher layers to lower layers, and/or from lower layers to higher layers. Information, signals, and so on may be input and/or output via a plurality of network nodes.

The information, signals, and so on that are input and/or output may be stored in a specific location (for example, a memory) or may be managed by using a management table. The information, signals, and so on to be input and/or output can be overwritten, updated, or appended. The information, signals, and so on that are output may be deleted. The information, signals, and so on that are input may be transmitted to another apparatus.

Reporting of information is by no means limited to the aspects/embodiments described in this specification, and other methods may be used as well. For example, reporting of information may be implemented by using physical layer signaling (for example, downlink control information (DCI), uplink control information (UCI), higher layer signaling (for example, RRC (Radio Resource Control) signaling, broadcast information (master information block (MIB), system information blocks (SIBs), and so on), MAC (Medium Access Control) signaling and so on), and other signals and/or combinations of these.

Note that physical layer signaling may be referred to as “L1/L2 (Layer 1/Layer 2) control information (L1/L2 control signals),” “L1 control information (L1 control signal),” and so on. Also, RRC signaling may be referred to as an “RRC message,” and can be, for example, an RRC connection setup (RRCConnectionSetup) message, an RRC connection reconfiguration (RRCConnectionReconfiguration) message, and so on. Also, MAC signaling may be reported using, for example, MAC control elements (MAC CEs).

Also, reporting of certain information (for example, reporting of “X holds”) does not necessarily have to be reported explicitly, and can be reported implicitly (by, for example, not reporting this certain information or reporting another piece of information).

Determinations may be made in values represented by one bit (0 or 1), may be made in Boolean values that represent true or false, or may be made by comparing numerical values (for example, comparison against a certain value).

Software, whether referred to as “software,” “firmware,” “middleware,” “microcode,” or “hardware description language,” or called by other terms, should be interpreted broadly to mean instructions, instruction sets, code, code segments, program codes, programs, subprograms, software modules, applications, software applications, software packages, routines, subroutines, objects, executable files, execution threads, procedures, functions, and so on.

Also, software, commands, information, and so on may be transmitted and received via communication media. For example, when software is transmitted from a website, a server, or other remote sources by using wired technologies (coaxial cables, optical fiber cables, twisted-pair cables, digital subscriber lines (DSL), and so on) and/or wireless technologies (infrared radiation, microwaves, and so on), these wired technologies and/or wireless technologies are also included in the definition of communication media.

The terms “system” and “network” used in this specification can be used interchangeably.

In the present specification, the terms “base station (BS),” “radio base station,” “eNB,” “gNB,” “cell,” “sector,” “cell group,” “carrier,” and “component carrier” may be used interchangeably. A base station may be referred to as a “fixed station,” “NodeB,” “eNodeB (eNB),” “access point,” “transmission point,” “receiving point,” “femto cell,” “small cell” and so on.

A base station can accommodate one or a plurality of (for example, three) cells (also referred to as “sectors”). When a base station accommodates a plurality of cells, the entire coverage area of the base station can be partitioned into multiple smaller areas, and each smaller area can provide communication services through base station subsystems (for example, indoor small base stations (RRHs (Remote Radio Heads)). The term “cell” or “sector” refers to part of or the entire coverage area of a base station and/or a base station subsystem that provides communication services within this coverage.

In the present specification, the terms “mobile station (MS),” “user terminal,” “user equipment (UE),” and “terminal” may be used interchangeably. A base station may be referred to as a “fixed station,” “NodeB,” “eNodeB (eNB),” “access point,” “transmission point,” “receiving point,” “femto cell,” “small cell” and so on.

A mobile station may be referred to, by a person skilled in the art, as a “subscriber station,” “mobile unit,” “subscriber unit,” “wireless unit,” “remote unit,” “mobile device,” “wireless device,” “wireless communication device,” “remote device,” “mobile subscriber station,” “access terminal,” “mobile terminal,” “wireless terminal,” “remote terminal,” “handset,” “user agent,” “mobile client,” “client,” or some other appropriate terms in some cases.

Furthermore, the radio base stations in this specification may be interpreted as user terminals. For example, each aspect/embodiment of the present invention may be applied to a configuration in which communication between a radio base station and a user terminal is replaced with communication among a plurality of user terminals (D2D (Device-to-Device)). In this case, the user terminals 20 may have the functions of the radio base stations 10 described above. In addition, wording such as “uplink” and “downlink” may be interpreted as “side.” For example, an uplink channel may be interpreted as a side channel.

Likewise, the user terminals in this specification may be interpreted as radio base stations. In this case, the radio base stations 10 may have the functions of the user terminals 20 described above.

Actions which have been described in this specification to be performed by a base station may, in some cases, be performed by upper nodes. In a network including one or a plurality of network nodes with base stations, it is clear that various operations that are performed to communicate with terminals can be performed by base stations, one or more network nodes (for example, MMEs (Mobility Management Entities), S-GW (Serving-Gateways), and so on may be possible, but these are not limiting) other than base stations, or combinations of these.

The aspects/embodiments illustrated in this specification may be used individually or in combinations, which may be switched depending on the mode of implementation. The order of processes, sequences, flowcharts, and so on that have been used to describe the aspects/embodiments herein may be re-ordered as long as inconsistencies do not arise. For example, although various methods have been illustrated in this specification with various components of steps in exemplary orders, the specific orders that are illustrated herein are by no means limiting.

The aspects/embodiments illustrated in this specification may be applied to LTE (Long Term Evolution), LTE-A (LTE-Advanced), LTE-B (LTE-Beyond), SUPER 3G, IMT-Advanced, 4G (4th generation mobile communication system), 5G (5th generation mobile communication system), FRA (Future Radio Access), New-RAT (Radio Access Technology), NR(New Radio), NX (New radio access), FX (Future generation radio access), GSM (registered trademark) (Global System for Mobile communications), CDMA 2000, UMB (Ultra Mobile Broadband), IEEE 802.11 (Wi-Fi (registered trademark)), IEEE 802.16 (WiMAX (registered trademark)), IEEE 802.20, UWB (Ultra-WideBand), Bluetooth (registered trademark), systems that use other adequate radio communication methods and/or next-generation systems that are enhanced based on these.

The phrase “based on” (or “on the basis of”) as used in this specification does not mean “based only on” (or “only on the basis of”), unless otherwise specified. In other words, the phrase “based on” (or “on the basis of”) means both “based only on” and “based at least on” (“only on the basis of” and “at least on the basis of”).

Reference to elements with designations such as “first,” “second” and so on as used herein does not generally limit the quantity or order of these elements. These designations may be used herein only for convenience, as a method for distinguishing between two or more elements. Thus, reference to the first and second elements does not imply that only two elements may be employed, or that the first element must precede the second element in some way.

The term “judging (determining)” as used herein may encompass a wide variety of actions. For example, “judging (determining)” may be interpreted to mean making “judgments (determinations)” about calculating, computing, processing, deriving, investigating, looking up, (for example, searching a table, a database, or some other data structures), ascertaining, and so on. Furthermore, “judging (determining)” may be interpreted to mean making “judgments (determinations)” about receiving (for example, receiving information), transmitting (for example, transmitting information), input, output, accessing (for example, accessing data in a memory), and so on. In addition, “judging (determining)” as used herein may be interpreted to mean making “judgments (determinations)” about resolving, selecting, choosing, establishing, comparing, and so on. In other words, “judging (determining)” may be interpreted to mean making “judgments (determinations)” about some action.

The terms “connected” and “coupled,” or any variation of these terms as used herein mean all direct or indirect connections or coupling between two or more elements, and may include the presence of one or more intermediate elements between two elements that are “connected” or “coupled” to each other. The coupling or connection between the elements may be physical, logical, or a combination thereof. For example, “connection” may be interpreted as “access.”

In this specification, when two elements are connected, the two elements may be considered “connected” or “coupled” to each other by using one or more electrical wires, cables and/or printed electrical connections, and, as some non-limiting and non-inclusive examples, by using electromagnetic energy having wavelengths in radio frequency regions, microwave regions and/or (both visible and invisible) optical regions, or the like.

In this specification, the phrase “A and B are different” may mean that “A and B are different from each other.” The terms “separate,” “be coupled” and so on may be interpreted similarly.

When terms such as “including,” “comprising,” and variations of these are used in this specification or in claims, these terms are intended to be inclusive, in a manner similar to the way the term “provide” is used. Furthermore, the term “or” as used in this specification or in claims is intended to be not an exclusive disjunction.

Now, although the present invention has been described in detail above, it should be obvious to a person skilled in the art that the present invention is by no means limited to the embodiments described in this specification. The present invention can be implemented with various corrections and in various modifications, without departing from the spirit and scope of the present invention defined by the recitations of claims. Consequently, the description in this specification is provided only for the purpose of explaining examples, and should by no means be construed to limit the present invention in any way.

1. A user terminal comprising:
a transmitting section that transmits one or more scheduling requests; and
a control section that controls transmission of the one or more scheduling requests, based on at least one of presence or absence of a configuration of a second PUCCH format, a number of configured PUCCH resource sets, and a number of scheduling request resource IDs corresponding to the one or more scheduling requests, when the one or more scheduling requests overlap uplink control information using a first PUCCH format.

2. The user terminal according to claim 1, wherein
when the second PUCCH format is configured or when the number of the configured PUCCH resource sets is larger than one, the control section performs control so that the one or more scheduling requests and the uplink control information are transmitted by using the second PUCCH format.

3. The user terminal according to claim 1, wherein
when the second PUCCH format is not configured or when the number of the configured PUCCH resource sets is one, the control section determines a resource to be used for transmission of the uplink control information, based on a type of the one or more scheduling requests.

4. The user terminal according to claim 1, wherein
when the number of the scheduling request resource IDs corresponding to the one or more scheduling requests is one, the control section determines a resource to be used for transmission of the uplink control information, based on a type of the one or more scheduling requests.

5. The user terminal according to claim 1, wherein
when the number of the scheduling request resource IDs corresponding to the one or more scheduling requests is larger than one, transmission of the one or more scheduling requests is controlled based on the presence or absence of the configuration of the second PUCCH format or the number of the configured PUCCH resource sets.

6. A radio communication method for a user terminal, the radio communication method comprising:
transmitting one or more scheduling requests; and
controlling transmission of the one or more scheduling requests, based on at least one of presence or absence of a configuration of a second PUCCH format, a number of configured PUCCH resource sets, and a number of scheduling request resource IDs corresponding to the one or more scheduling requests, when the one or more scheduling requests overlap uplink control information using a first PUCCH format.

7. The user terminal according to claim 2, wherein
when the second PUCCH format is not configured or when the number of the configured PUCCH resource sets is one, the control section determines a resource to be used for transmission of the uplink control information, based on a type of the one or more scheduling requests.

8. The user terminal according to claim 4, wherein
when the number of the scheduling request resource IDs corresponding to the one or more scheduling requests is larger than one, transmission of the one or more scheduling requests is controlled based on the presence or absence of the configuration of the second PUCCH format or the number of the configured PUCCH resource sets.
